(19) United States
(12) Patent Application Publication
(10) Pub. No.: US 2008/0071464 A1
(43) Pub. Date: Mar. 20, 2008

(54) Control apparatus and control method for internal combustion engine

(75) Inventor: Shuichi Hanai, Toyota-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 11/898,588

(22) Filed: Sep. 13, 2007

(30) Foreign Application Priority Data
Sep. 14, 2006 (JP) 2006-249391

(51) Int. Cl. F02D 28/00

(52) U.S. Cl. 701/102

(57) ABSTRACT

A control apparatus for an internal combustion engine for a vehicle includes a coolant temperature increase device, an operation control device, and an ignition timing retard control device. The coolant temperature increase device increases a coolant temperature. The operation control device executes an engine control in response to an instruction provided by a driver. During the engine control power performance provided by the internal combustion engine in response to an operation performed by the driver is lower than power performance that is normally provided in response to the operation performed by the driver. The ignition timing retard control device executes an ignition timing retard control to prevent knocking. In the control apparatus, when the operation control device executes the engine control, the coolant temperature increase device increases the coolant temperature.

### INCORPORATION BY REFERENCE

The disclosure of Japanese Patent Application No. 2006-249391 filed on Sep. 14, 2006 including the specification, drawings and abstract is incorporated herein by reference in its entirety.

### BACKGROUND OF THE INVENTION

1. Field of the Invention

The invention relates to a control apparatus for an internal combustion engine for a vehicle, which includes a coolant temperature adjustment mechanism that adjusts the temperature of coolant for the internal combustion engine, and a control method for an internal combustion engine for a vehicle.

2. Description of the Related Art

Japanese Patent Application Publication No. 2004-204740 (JP-A-2004-204740) describes a coolant temperature increase control that increases a coolant temperature by adjusting the flow of coolant using an electronic thermostat or the like at the time of low-load operation to decrease friction loss and cooling loss, thereby improving fuel efficiency of an internal combustion engine (refer to Pages 6 to 8, FIGS. 1 to 5).

When a driver depresses an accelerator pedal to sharply accelerate the vehicle, the coolant temperature increase control is stopped due to a change in the operating state of the internal combustion engine from the low-load operating state to the high-load operating state. When the coolant temperature increase control is stopped, the coolant temperature is not sharply decreased. Time is required until the coolant from which heat is dissipated in a radiator reaches an area around a cylinder bore and absorbs beat, and thus the temperature of the internal combustion engine is decreased Thus, although the operating state of the internal combustion engine is quickly changed from the low-load operating state to the high-load operating state, the coolant temperature is decreased extremely slowly in response to the change in the operating state.

Therefore, the coolant temperature is transiently high during the high-load operation, and as a result, the frequency of occurrence of knocking is increased. Thus, an ignition timing retard process is executed to prevent knocking. Because the ignition is retarded, power performance provided in response to an increase in an accelerator-pedal operation amount is lower than power performance that is normally provided in response to the increase in the accelerator-pedal operation amount, that is, the power performance of the internal combustion engine is decreased.

Because a driver is not aware of the coolant temperature increase control, the driver only recognizes that the internal combustion engine is slowly accelerated due to the decrease in the power performance of the internal combustion engine. This makes the driver feel discomfort.

Taking into account that the internal combustion engine may be sharply accelerated, the coolant temperature is not increased to the highest possible level at the time of low-load operation. Thus, the coolant temperature is increased to a level that is much lower than the highest possible level. That is, a process for sufficiently reduce the fuel consumption is not executed, taking into account the possibility that the driver may feel discomfort.

### SUMMARY OF THE INVENTION

The invention increases a coolant temperature as compared to a conventional case, without making a driver feel discomfort, thereby further improving fuel efficiency.

A first aspect of the invention relates to a control method for an internal combustion engine for a vehicle. The control method includes increasing a temperature of coolant for the internal combustion engine, in a situation where an ignition timing retard control device is provided to execute an ignition timing retard control to prevent knocking, and a driver recognizes that an engine control is executed, wherein power performance provided by the internal combustion engine in response to an operation performed by a driver is lower than power performance that is normally provided in response to the operation performed by the driver during the engine control.

Thus, in the situation where the driver recognizes that the engine control is executed, the coolant temperature is increased. During the engine control, the power performance provided by the internal combustion engine is lower than the power performance that is normally provided. In the situation where the coolant temperature is increased, when the driver performs an acceleration operation to increase the load of the internal combustion engine, and accordingly the frequency of occurrence of knocking is increased, the ignition timing retard control is executed to prevent knocking.

Because the power performance is decreased by the ignition timing retard control, the internal combustion engine is slowly accelerated temporarily. However, at this time, the driver recognizes that the engine control is executed. During the engine control, the power performance provided by the internal combustion engine in response to the operation performed by the driver is lower than the power performance that is normally provided in response to the operation performed by the driver. Thus, the driver considers that the internal combustion engine is slowly accelerated due to the influence of the engine control. Therefore, the driver does not feel discomfort. Thus, when the coolant temperature is set to the highest possible value at the time of low-load operation, or a value near the highest possible value, and the internal combustion engine is slowly accelerated thereafter, the driver does not feel discomfort. In this manner, the coolant temperature is increased as compared to the conventional case, without making the driver feel discomfort. This further improves fuel efficiency.

A second aspect of the invention relates to a control apparatus for an internal combustion engine for a vehicle. The control apparatus includes a coolant temperature increase device that increases a coolant temperature that is a temperature of coolant for the internal combustion engine; an operation control device that executes an engine control in response to an instruction provided by a driver, wherein power performance provided by the internal combustion engine in response to an operation performed by the driver is lower than power performance that is normally provided in response to the operation performed by the driver during the engine control; and an ignition timing retard control device that executes an ignition timing retard control to prevent knocking. In the control apparatus, when the operation control device executes the engine control, the coolant temperature increase device increases the coolant temperature.

Because the operation control device executes the engine control in response to the instruction provided by the driver, the driver recognizes that the power performance is lower than normal. Thus, when the coolant temperature is set to the highest possible value at the time of low-load operation, or a value near the highest possible value, and the internal combustion engine is slowly accelerated thereafter, the driver does not feel discomfort. In this manner, the coolant temperature is increased as compared to the conventional case, without making the driver feel discomfort. This further improves fuel efficiency.

In the second aspect the engine control may include a fuel consumption reduction mode.

The engine control executed to suppress the power performance of the internal combustion engine includes the fuel consumption reduction mode. When the engine control is executed, the power performance provided by the internal combustion engine in response to the driver's operation is lower than the power performance that is normally provided in response to the driver's operation. When the engine control is executed, the coolant temperature increase device increases the coolant temperature. Thus, when the acceleration operation is performed thereafter, and the internal combustion engine is slowly accelerated temporarily, the driver does not feel discomfort as described above, because the driver recognizes that the engine control is executed to suppress the power performance. In this manner, the coolant temperature increase device increases the coolant temperature as compared to the conventional case, without making the driver feel discomfort. This further improves fuel efficiency.

A third aspect of the invention relates to a control method for an internal combustion engine for a vehicle. The control method includes increasing a temperature of coolant for the internal combustion engine, in a situation where an ignition timing retard control device is provided to execute an ignition timing retard control to prevent knocking, and a driver recognizes that an engine control is executed, wherein the internal combustion engine is accelerated more slowly than normal during the engine control.

Thus, in the situation where the driver recognizes that the engine control is executed, the coolant temperature is increased. During the engine control, the internal combustion engine is accelerated more slowly than normal. In the situation where the coolant temperature is increased, when the driver performs an acceleration operation to increase the load of the internal combustion engine, and accordingly the frequency of occurrence of knocking is increased, the ignition timing retard control is executed to prevent knocking.

Because the power performance is decreased by the ignition timing retard control, the internal combustion engine is slowly accelerated. However, at this time, the driver recognizes that the engine control has been executed. During the engine control, the internal combustion engine is accelerated more slowly than normal. Therefore, when the internal combustion engine is slowly accelerated immediately after the engine control is stopped, the driver does not feel discomfort. Thus, when the coolant temperature is set to the highest possible value at the time of low-load operation, or a value near the highest possible value, and the internal combustion engine is slowly accelerated thereafter, the driver does not feel discomfort. In this manner, the coolant temperature is increased as compared to the conventional case, without making the driver feel discomfort This further improves fuel efficiency.

A fourth aspect of the invention relates to a control apparatus for an internal combustion engine for a vehicle. The control apparatus includes a coolant temperature increase device that increases a coolant temperature that is a temperature of coolant for the internal combustion engine; an operation control device that executes an engine control in response to an instruction provided by a driver, wherein the internal combustion engine is accelerated more slowly than normal during the engine control; and an ignition timing retard control device that executes an ignition timing retard control to prevent knocking. In the control apparatus, when the operation control device executes the engine control, the coolant temperature increase device increases the coolant temperature.

Because the operation control device executes the engine control in response to the instruction provided by the driver, the driver recognizes that the internal combustion engine is accelerated more slowly than normal. Thus, when the coolant temperature is set to the highest possible value at the time of low-load operation, or a value near the highest possible value, and the internal combustion engine is slowly accelerated temporarily thereafter, the driver does not feel discomfort. In this manner, the coolant temperature is increased as compared to the conventional case, without making the driver feel discomfort. This further improves fuel efficiency.

In the fourth aspect, the engine control may include a cruise control.

The engine control, during which the internal combustion engine is accelerated more slowly than normal, includes the cruise control. When the engine control is executed, the coolant temperature increase device increases the coolant temperature. Thus, when the acceleration operation is performed thereafter, and the internal combustion engine is slowly accelerated temporarily, the driver does not feel discomfort as described above, because the driver recognizes that the engine control is executed. In this manner, the coolant temperature increase device increases the coolant temperature as compared to the conventional case, without making the driver feel discomfort. This further improves fuel efficiency.

A fifth aspect of the invention relates to a control method for an internal combustion engine for a vehicle. The control method includes increasing a temperature of coolant for the internal combustion engine, in a situation where an ignition timing retard control device is provided to execute an ignition timing retard control to prevent knocking, and a fuel consumption reduction mode is selected in response to an instruction provided by a driver.

When the fuel consumption reduction mode is selected in response to the driver's instruction, the coolant temperature is increased. That is, in the situation where the driver recognizes that the fuel consumption reduction mode is selected, the coolant temperature is increased. In the situation where the coolant temperature is increased, when the driver performs an acceleration operation to increase the load of the internal combustion engine, and accordingly the frequency of occurrence of knocking is increased, the ignition timing retard control is executed to prevent knocking.

Because the power performance is decreased by the ignition timing retard control, the internal combustion engine is slowly accelerated temporarily. However, at this time, the driver recognizes that the fuel consumption reduction mode is executed. Therefore, the driver considers that the internal combustion engine is slowly accelerated due to the influence of the fuel consumption reduction mode. Thus, when the coolant temperature is set to the highest possible value at the time of low-load operation, or a value near the highest possible value, and the internal combustion engine is slowly accelerated thereafter, the driver does not feel discomfort. In this manner, the coolant temperature is increased as compared to the conventional case, without making the driver feel discomfort. This further improves fuel efficiency.

A sixth aspect of the invention relates to a control apparatus for an internal combustion engine for a vehicle. The control apparatus includes a coolant temperature increase device that increases a coolant temperature that is a temperature of coolant for the internal combustion engine; a fuel consumption reduction mode selection device that selects a fuel consumption reduction mode in response to an instruction provided by a driver, and an ignition timing retard control device that executes an ignition timing retard control to prevent knocking. In the control apparatus, when the fuel consumption reduction mode is selected, the coolant temperature increase device increases the coolant temperature.

Because the fuel consumption reduction mode device selects the fuel consumption reduction mode in response to the instruction provided by the driver, the driver recognizes that the fuel consumption reduction mode is selected. Thus, when the coolant temperature is set to the highest possible value at the time of low-load operation, or a value near the highest possible value, and the internal combustion engine is slowly accelerated thereafter, the driver does not feel discomfort. In this manner, the coolant temperature is increased as compared to the conventional case, without making the driver feel discomfort. This further improves fuel efficiency.

In the above-described aspect, the control apparatus may further include a load-based coolant temperature adjustment device that increases the coolant temperature as a load of the internal combustion engine decreases when the engine control is not executed, or when the fuel consumption reduction mode is not selected. The coolant temperature increase device may adjust the coolant temperature to a higher value than a value to which the coolant temperature is adjusted by the load-based coolant temperature adjustment device.

When the load-based coolant temperature adjustment device increases the coolant temperature as the load of the internal combustion engine decreases, the coolant temperature is not adjusted to the highest possible value at the time of low-load operation or a value near the highest possible value, because it is necessary to prevent the internal combustion engine from being slowly accelerated at ordinary times. Thus, the upper limit of the coolant temperature is set to a value that is somewhat lower than the highest possible value. However, when the coolant temperature increase device adjusts the coolant temperature to a value higher than the upper limit used by the load-based coolant temperature adjustment device, and the internal combustion engine is slowly accelerated temporarily, the driver does not feel discomfort. Thus, when the coolant temperature increase device adjusts the coolant temperature to a higher value than a value to which the coolant temperature is adjusted by the load-based coolant temperature adjustment device, the fuel efficiency is further improved without making the drive feel discomfort.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a block diagram showing the schematic configuration of a control apparatus for an internal combustion engine for a vehicle and a coolant temperature adjustment mechanism according to a first embodiment;

FIG. 2 is a diagram showing values of a target coolant temperature THWt set based on the operating state of the internal combustion engine;

FIG. 3 is a flowchart of a coolant temperature control routine executed by an ECU in the first and second embodiments;

FIG. 4 is a timing chart showing an example of the control in the first embodiment;

FIG. 5 is a flowchart of a coolant temperature control routine executed by the ECU in a third embodiment;

FIG. 6 is a flowchart of a coolant temperature control routine executed by the ECU in a fourth embodiment;

FIG. 7 is a graph showing the value of the target coolant temperature THWt at each fuel consumption reduction mode in the fourth embodiment; and

FIG. 8 is a timing chart showing an example of the control in the fourth embodiment.

### DETAILED DESCRIPTION OF THE EMBODIMENTS

### First Embodiment

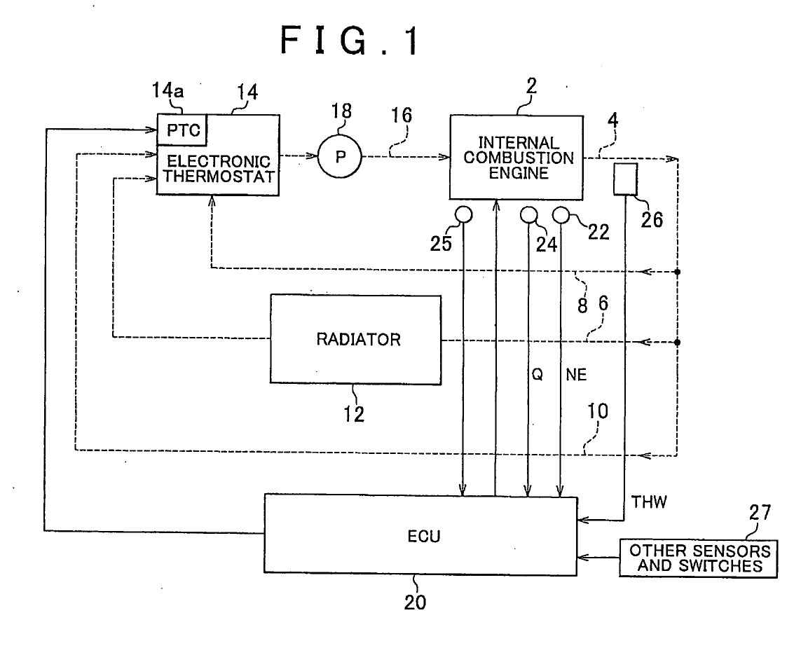

FIG. 1 is a block diagram showing the schematic configuration of a control apparatus for an internal combustion engine for a vehicle and a coolant temperature adjustment mechanism, to which the above-described invention is applied. The control apparatus for an internal combustion engine controls operation of an internal combustion engine 2. In addition, the control apparatus controls the temperature of the internal combustion engine 2 by adjusting the temperature of coolant that flows in a coolant passage that includes a water jacket formed in the cylinder block and the cylinder head of the internal combustion engine 2.

As shown in FIG. 1, after the coolant flows out of the internal combustion engine 2, the coolant flows into a cooling passage 6, and bypass passages (a main bypass passage 8, and a sub bypass passage 10) via an outlet passage 4. A radiator 12, which cools the coolant, is provided in the cooling passage 6.

The coolant, which flows in the cooling passage 6, passes through the radiator 12, and then flows into an electronic thermostat 14 that is electronically controlled. The coolant, which flows in the bypass passages 8 and 10, flows into the electronic thermostat 14 without passing through the radiator 12. The coolant, which flows out of the electronic thermostat 14, is supplied to the internal combustion engine 2 via an inlet passage 16. A water pump 18, which forcibly moves the coolant, is provided in the inlet passage 16. The water pump 18 is driven by power output from the internal combustion engine 2.

The electronic thermostat 14 controls the ratio between the flow amount of the coolant that flows in the coolant passage 6, and passes through the radiator 12, and then flows into the inlet passage 16, and the flow amount of the coolant that flows in the main bypass passage 8, and then flows into the inlet passage 16. In the electronic thermostat 14, a mechanical control for a valve element is executed so that the valve element is mechanically placed in an open position and a closed position according to the temperature of the coolant flowing into the electronic thermostat 14 from the sub bypass passage 10, using a temperature detection portion provided in the electronic thermostat 14. Further, a PTC (Positive Temperature Coefficient) heater 14a is provided in the temperature detection portion in the electronic thermostat 14. The PTC heater 14a electrically generates heat. By controlling the supply of electric power to the PTC heater 14a, an electronic control for the valve element is executed so that the valve element is electronically placed in the open position and the closed position, separately from the above-described mechanical control.

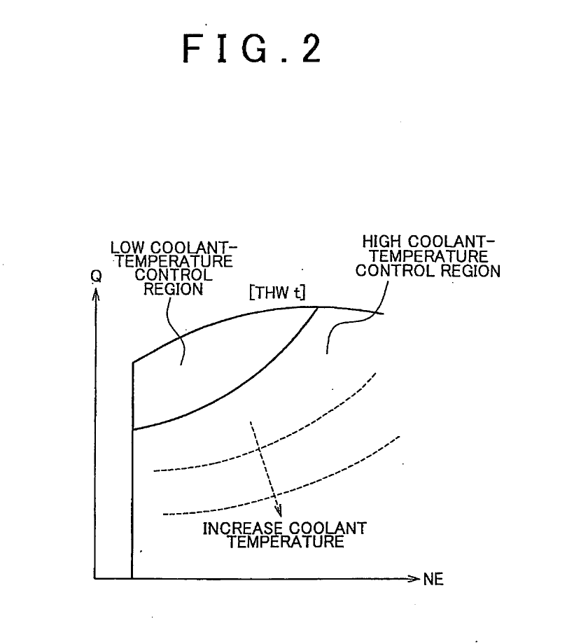

Results of detection performed by sensors are taken in an electronic control unit (hereinafter, referred to as “ECU”) 20 that controls the internal combustion engine 2 and the electronic thermostat 14. After predetermined calculation is performed, a control signal is output. In the embodiment, an engine speed sensor 22, an airflow meter. 24, a knocking sensor 25, a coolant temperature sensor 26, and other sensor and switches 27 (including a cruise control switch) are provided. The engine speed sensor 22 detects the rotational speed of the internal combustion engine 2. The airflow meter 24 detects the amount of air taken into the internal combustion engine 2 (hereinafter, referred to as “intake air amount”). The coolant temperature sensor 26 detects a coolant temperature THW in the outlet passage 4. Based on values detected by the airflow meter 24 and the engine speed sensor 22, the intake air amount (load) Q and the engine speed NE are determined, respectively. Based on the load Q and the engine speed NE, a target coolant temperature THWt is calculated using a map shown in FIG. 2. The supply of electric power to the PTC heater 14a of the electronic thermostat 14 is controlled so that the coolant temperature THW detected by the coolant temperature sensor 26 is equal to the target coolant temperature THWt.

In the map used in a control according to the embodiment, a low coolant-temperature control region is set on a side where the load Q is high. When a point indicating the operating state of the internal combustion engine 2 is in the low coolant-temperature control region, the ECU 20 opens the electronic thermostat 14 to a large extent so that a large amount of coolant flows into the inlet passage 16 from the cooling passage 6. Thus, a large amount of coolant, from which beat has been dissipated in the radiator 12, flows in the water jacket in the internal combustion engine 2. As a result, the internal combustion engine 2 is sufficiently cooled. In the low coolant-temperature control region, for example, the target coolant temperature THWt is set to 90° C.

On the side where the load Q is low, a high coolant-temperature control region is set. When the point indicating the operating state of the internal combustion engine 2 is in the high coolant-temperature control region, the ECU 20 increases the target coolant temperature THWt as the load Q decreases. That is, the ECU 20 decreases the opening degree of the electronic thermostat 14 as the load Q decreases. Thus, as the load Q decreases, the coolant flowing in the cooling passage 6 is less likely to flow into the inlet passage 16. Accordingly, the amount of coolant that flows into the inlet passage 16 via the main bypass passage 8 increases. As a result, a large amount of coolant, which has not passed through the radiator 12 for heat dissipation, flows in the water jacket in the internal combustion engine 2. This increases the temperature of the internal combustion engine 2.

When the ECU 20 controls the operation of the internal combustion engine 2, the ECU 20 may execute an anti-knocking control, that is, an ignition timing retard control to prevent knocking. In the internal combustion engine 2 where such an anti-knocking control may be executed, if the temperature of the coolant is adjusted to the highest possible value at the time of low-load operation or a value near the highest possible value, and an acceleration operation is performed during the low-load operation, the frequency of occurrence of knocking is increased, because the temperature of the coolant flowing into the internal combustion engine 2 is not immediately decreased. Therefore, the ECU 20 executes the anti-knocking control, thereby retarding the ignition timing. This ignition timing retard process temporarily decreases the power performance of the internal combustion engine 2. As a result, a driver may feel discomfort (more specifically, the driver may feel that an internal combustion engine is slowly accelerated). Therefore, when the coolant temperature is increased according to the operating state (mainly the load Q) of the internal combustion engine 2 as shown in FIG. 2, the coolant temperature is not adjusted to the highest possible value at the time of low-load operation or a value near the highest possible value. Thus, the upper limit of the target coolant temperature THWt is set to a value of the coolant temperature THW, at which the driver does not feel discomfort when the acceleration operation is performed. For example, the upper limit of the target coolant temperature THWt is set to 95° C. More specifically, in the low-coolant temperature control region, the target coolant temperature THWt is set to 90° C., and in the high-coolant temperature control region, the target coolant temperature THWt is set to 90° C. to 95° C.

However, the ECU 20 executes a coolant temperature increase process in which the target coolant temperature THWt is set to 100° C. during a cruise control as described below, separately from the coolant temperature control executed according to the operating state of the internal combustion engine 2 as shown in FIG. 2. When the cruise control is executed, data communication is performed between the ECU 20 and an inter-vehicle ECU that includes an inter-vehicle sensor, and between the ECU 20 and a brake ECU that controls a brake actuator.

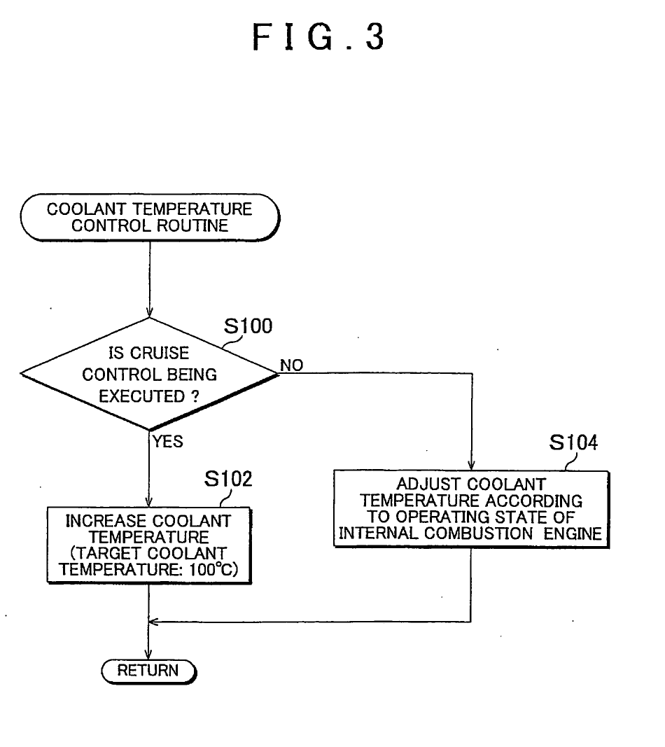

FIG. 3 shows a flowchart of a coolant temperature control routine executed by an ECU 20. This routine is repeatedly executed at constant time intervals. When this routine is started, it is determined whether the cruise control is currently being executed (S100). When the cruise control is not currently being executed (NO in step S100), the coolant temperature is adjusted according to the operating state of the internal combustion engine 2 (S104). That is, by adjusting the electronic thermostat 14, the coolant temperature THW is controlled as shown in FIG. 2. In the temperature range shown in FIG. 2, the upper limit of the target coolant temperature THWt is set to 95° C. to prevent the driver from feeling that the internal combustion engine 2 is slowly accelerated, as described above.

The cruise control is started when the driver provides an instruction by operating the cruise control switch. When the cruise control is being executed (YES in step S100), the coolant temperature increase process, i.e., the process, in which the coolant temperature THW is increased, is executed (S102). That is, the process, in which the target coolant temperature THWt is set to 100° C., is executed as described above. Thus, friction loss and cooling loss is further reduced, as compared to when the coolant temperature is adjusted according to the operating state of the internal combustion engine 2 (S104).

When the internal combustion engine 2 is placed in a high-load state due to the driver's acceleration operation using an accelerator pedal during the coolant temperature increase process, the cruise control is immediately stopped (NO in step S100), and the coolant temperature is adjusted according to the operating state of the internal combustion engine 2 (S104). However, because time is required until the temperature of the internal combustion engine 2 is changed due to heat migration such as heat transfer and heat conduction, knocking is likely to occur until the actual coolant temperature THW reaches the target coolant temperature THWt shown in FIG. 2. Accordingly, the ECU 20 executes the anti-knocking control, thereby retarding the ignition timing. This decreases the power performance of the internal combustion engine 2. Thus, the output is increased in response to the acceleration operation more slowly than normal, and therefore, the internal combustion engine 2 is slowly accelerated temporarily.

However, the cruise control is the engine control during which the internal combustion engine 2 is not sharply accelerated, i.e., the internal combustion engine 2 is accelerated more slowly than normal. Further, because the driver selects the cruise control by operating the cruise control switch, the driver recognizes that the internal combustion engine 2 is slowly accelerated temporarily due to the influence of the cruise control, and thus the driver does not feel discomfort.

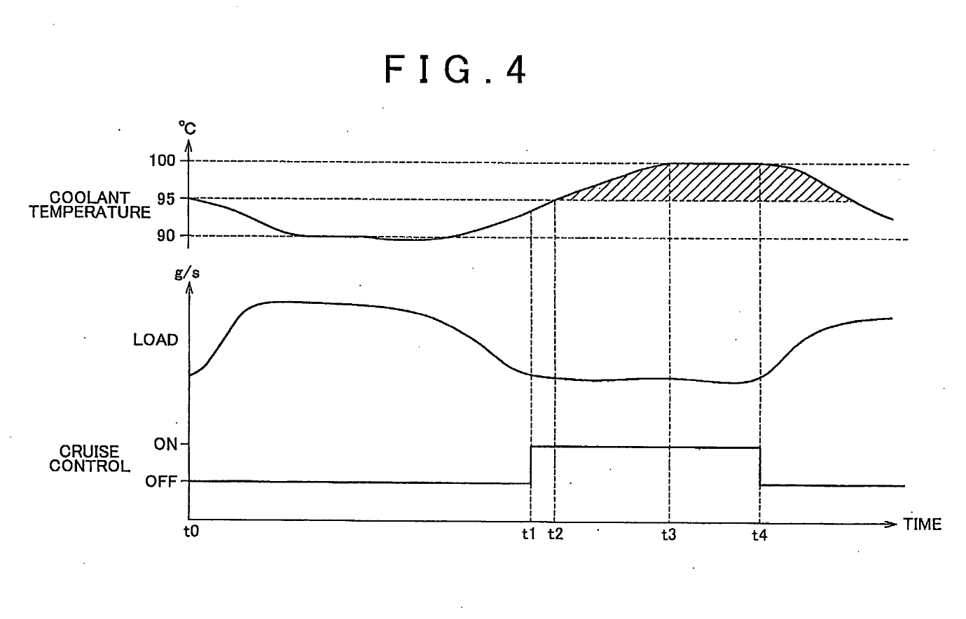

FIG. 4 shows a timing chart of an example of the control according to the embodiment. Because the cruise control is not executed before time point t1, the electronic thermostat 14 is adjusted according to the target coolant temperature THWt that is set to a value in the range of 90° C. to 95° C. based on the operating state of the internal combustion engine 2, as shown in FIG. 2. Accordingly, when the driver performs the acceleration operation at time point to, the ignition timing is not retarded by the anti-knocking control because the coolant temperature is equal to or below 95° C. Thus, the driver does not feel that the internal combustion engine 2 is slowly accelerated.

When the cruise control is started in response to the driver's instruction at time point t1, the target coolant temperature THWt is set to 100° C. Accordingly, the coolant temperature exceeds 95° C. at time point t2, and the cruise control continues to be executed after time point t2, and thus, the coolant temperature reaches 100° C. at time point t3. In FIG. 4, the hatched range indicates the range where the coolant temperature THW is above 95° C., i.e., the range of values to which the coolant temperature THW is not normally adjusted.

Then, after the coolant temperature remains 100° C., the driver performs the acceleration operation using the accelerator pedal, and accordingly the cruise control is stopped at time point t4. As a result, the internal combustion engine 2 is temporarily placed in a high-temperature high-load state. Therefore, the frequency of occurrence of knocking is increased, and thus the ignition timing is retarded by the anti-knocking control. Accordingly, the internal combustion engine 2 is slowly accelerated temporarily due to the decrease in the power performance of the internal combustion engine 2. However, because the driver performs the acceleration operation using the accelerator pedal during the cruise control, the driver does not feel discomfort for the reason described above.

In the above-described configuration, the mechanism that adjusts the coolant temperature THW using the electronic thermostat 14 as shown in FIG. 1 may be regarded as the coolant temperature adjustment mechanism. The ECU may be regarded as the coolant temperature increase device, and the load-based coolant temperature adjustment device. Among the processes executed by the ECU, the cruise control may be regarded as the process executed by the operation control device. The coolant temperature increase process (S102) may be regarded as the process executed by the coolant temperature increase device. The process, in which the coolant temperature is adjusted according to the operating state of the internal combustion engine 2 (S104), may be regarded as the process executed by the load-based coolant temperature adjustment device.

In the first embodiment thus described, the following advantageous effects are obtained. (i) When the cruise control is executed in response to the driver's instruction, the driver recognizes that the engine control is executed. During the engine control, the internal combustion engine 2 is accelerated more slowly than normal In this situation, when the driver performs the acceleration operation using the accelerator pedal, the above-described engine control is stopped, and the ignition timing retard control is executed to prevent knocking, and thus, the internal combustion engine 2 is slowly accelerated temporarily as described above. However, because the driver recognizes that the above-described engine control (the cruise control) is executed in response to the driver's instruction as described above, the driver recognizes that the internal combustion engine is slowly accelerated due to the influence of the engine control. Therefore, the driver does not feel discomfort In this manner, the coolant temperature is increased as compared to the conventional case, without making the driver feel discomfort. This further improves fuel efficiency.

(ii) When the cruise control is not executed, i.e., during the ordinary operation, the coolant temperature is increased during the low-load operation as shown in FIG. 2. This reduces the fuel consumption. However, when the cruise control is executed, the coolant temperature is adjusted to a higher value than a value to which the coolant temperature is adjusted based on the map shown in FIG. 2, without making the driver feel discomfort. This further improves the fuel efficiency.

### Second Embodiment

In the second embodiment, a fuel consumption reduction mode is executed in association with the cruise control. More specifically, in the fuel consumption reduction mode, a lean burn control that limits a combustion to a lean combustion (or a stratified combustion control that limits a combustion to a stratified combustion) may be executed as a combustion control for the internal combustion engine 2 for a vehicle. The fuel consumption reduction mode further includes a throttle-valve opening degree increase suppression control and an engine speed suppression control. The throttle-valve opening degree increase suppression control limits an increase amount, by which a throttle-valve opening degree is increased, to a small amount in the internal combustion engine 2. The engine speed suppression control sets the upper limit of the engine speed NE to a lower value than normal. In the fuel consumption reduction mode, one of the throttle-valve opening degree increase suppression control, the engine speed suppression control, and the above-described combustion control including the lean burn control and the stratified combustion control may be executed. Alternatively, two or more of the controls may be executed in combination. The other portions of the configuration in the second embodiment are the same as those of the configuration in the first embodiment (refer to FIG. 1 to FIGS. 3).

Accordingly, when the cruise control is executed, the driver recognizes that the engine control is executed. During the engine control, the power performance provided by the internal combustion engine 2 in response to the driver's operation is lower than the power performance that is normally provided in response to the driver's operation.

In the second embodiment thus described, the following advantageous effects are obtained. (i) In the second embodiment, when the cruise control is executed in response to the driver's instruction, the driver recognizes that the engine control is executed. During the engine control, the power performance provided by the internal combustion engine 2 in response to the driver's operation is lower than the power performance that is normally provided in response to the driver's operation. In this situation, when the driver performs the acceleration operation, the ignition timing retard control is executed to prevent knocking, and thus the internal combustion engine 2 is slowly accelerated temporarily. However, at this time, the driver recognizes that the above-described engine control is executed in response to the driver's instruction. Therefore, when the coolant temperature is set to the highest possible value (100° C.) at the time of low-load operation, or a value near the highest possible value, and the internal combustion engine 2 is slowly accelerated temporarily thereafter, the driver does not feel discomfort because the driver recognizes that the internal combustion engine is slowly accelerated due to the influence of the engine control. In this manner, the coolant temperature is increased as compared to the conventional case, without making the driver feel discomfort. This further improves the fuel efficiency. (ii) It is possible to obtain the same advantageous effect as that described in the section (ii) in the first embodiment.

### Third Embodiment

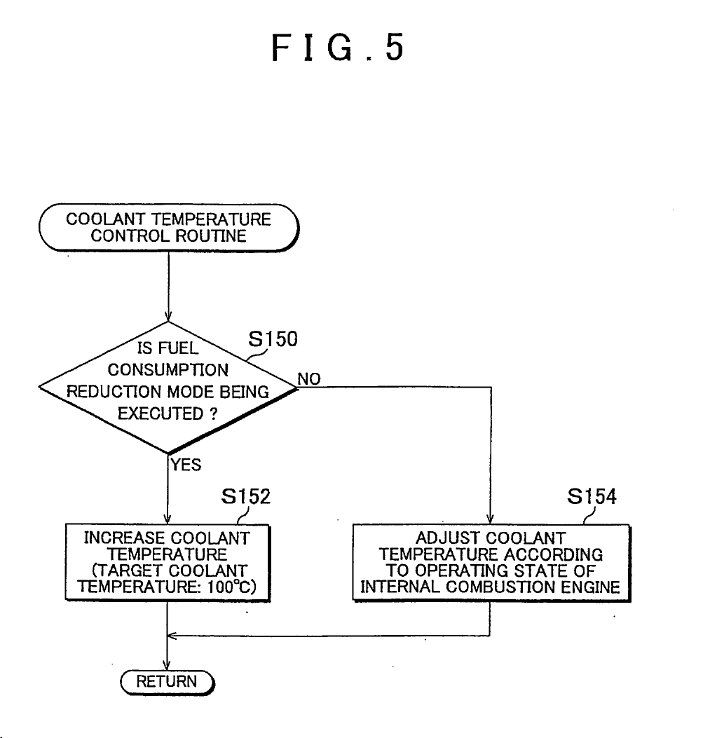

The third embodiment differs from the first embodiment in that the ECU 20 executes a coolant temperature control routine shown in FIG. 5 instead of the coolant temperature control routine shown in FIG. 3. Further, a fuel consumption reduction mode switch is provided in the dashboard of the vehicle, instead of the cruise control switch. The fuel consumption reduction mode switch is used to turn the fuel consumption reduction mode on and off. As in the second embodiment, in the fuel consumption reduction mode, one of the throttle-valve opening degree increase suppression control, the engine speed suppression control, and the above-described combustion control including the lean burn control and the stratified combustion control may be executed. Alternatively, two or more of the controls may be executed in combination. When the internal combustion engine is placed in the high-load state due to, for example, the driver's operation for sharply accelerating the accelerator pedal, the fuel consumption reduction mode is stopped. The other portions of the configuration of the third embodiment are the same as those of the configuration of the first embodiment (refer to FIGS. 1 and 2).

The coolant temperature control routine (FIG. 5) is executed at constant time intervals. When the coolant temperature control routine is started, first, it is determined whether the fuel consumption reduction mode is currently being executed (S150). When the fuel consumption reduction mode is not being executed (NO in step S150), the coolant temperature is adjusted according to the operating state of the internal combustion engine 2 (S154). This process is the same as the process in step S104 in FIG. 3. By adjusting the electronic thermostat 14, the coolant temperature THW is controlled in the temperature range where the upper limit is 95° C., as shown in FIG. 2.

The fuel consumption reduction mode is started when the driver provides an instruction by operating the fuel consumption reduction mode switch. When the fuel consumption reduction mode is being executed (YES in step S150), the coolant temperature increase process is executed, i.e., the process, in which the coolant temperature THW is increased, is executed (S152). That is, the coolant temperature THW is adjusted to 100° C. as in step S102 in FIG. 3. This further reduces the friction loss and cooling loss.

When the internal combustion engine 2 is placed in the high-load state, for example, due to the driver's operation for sharply accelerating the internal combustion engine 2 during the coolant temperature increase process in step S152, the fuel consumption reduction mode is immediately stopped (NO in step S150), and the coolant temperature is adjusted according to the operating state of the internal combustion engine 2 (S154). At this time, knocking is likely to occur temporarily, as described in the first embodiment. Accordingly, the ECU executes the anti-knocking control, thereby retarding the ignition timing. Thus, the power performance of the internal combustion engine 2 is decreased, and the output is increased more slowly than normal in response to the acceleration operation. That is, the internal combustion engine 2 is slowly accelerated temporarily. However, because the driver recognizes that the internal combustion engine 2 is slowly accelerated due to the influence of the fuel consumption reduction mode, the driver does not feel discomfort when the internal combustion engine 2 is slowly accelerated temporarily, immediately after the fuel consumption reduction mode is stopped.

In the above-described configuration, the ECU may be regarded as the operation control device, the coolant temperature increase device, and the load-based coolant temperature adjustment device. Among the processes executed by the ECU, the process, in which the fuel consumption reduction mode is executed, may be regarded as the process executed by the operation control device. The coolant temperature increase process (S152) may be regarded as the process executed by the coolant temperature increase device. The process, in which the coolant temperature is adjusted according to the operating state of the internal combustion engine 2 (S154), may be regarded as the process executed by the load-based coolant temperature adjustment device.

In the third embodiment thus described, the following advantageous effects are obtained. (i) When the fuel consumption reduction mode is executed in response to the driver's instruction, the driver recognizes that the engine control is executed. During the engine control, the power performance provided by the internal combustion engine 2 in response to the driver's operation of depressing the accelerator pedal is lower than the power performance that is normally provided in response to the driver's operation. In this situation, when the internal combustion engine 2 is placed in the high-load state due to the driver's operation for sharply accelerating the internal combustion engine 2, the ignition timing retard control is executed to prevent knocking, and thus the internal combustion engine 2 is slowly accelerated temporarily. However, at this time, the driver recognizes that the above-described engine control is executed in response to the driver's instruction. Therefore, the driver does not feel discomfort That is, the driver does not feel discomfort when the coolant temperature is set to the highest possible value (100° C.) at the time of low-load operation, or a value near the highest possible value, and the internal combustion engine 2 is slowly accelerated temporarily thereafter. In this manner, the coolant temperature is increased without making the driver feel discomfort. This further improves fuel efficiency. (ii) It is possible to obtain the same advantageous effect as that described in the section (ii) in the first embodiment.

### Fourth Embodiment

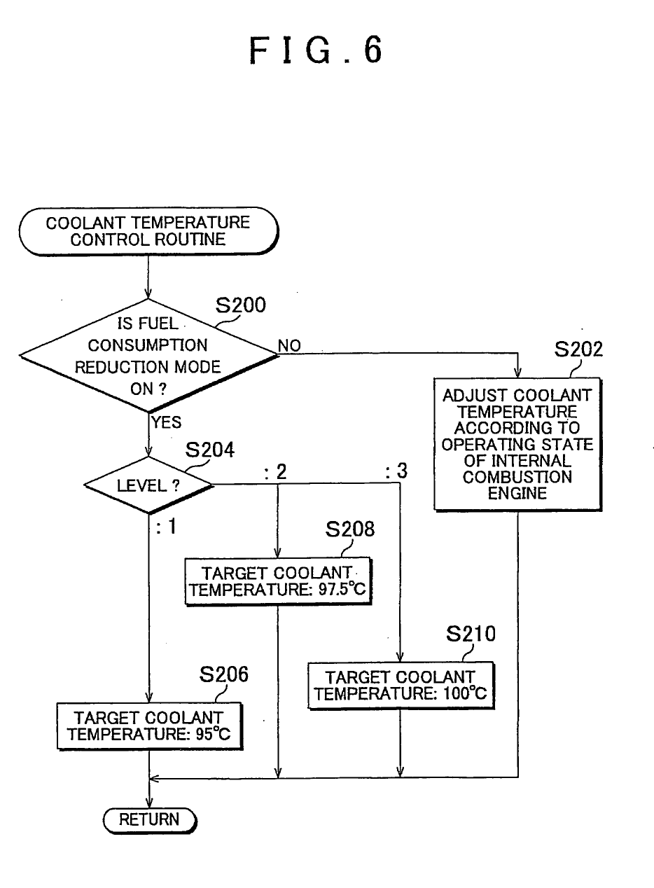

The fourth embodiment differs from the first embodiment in that the ECU 20 executes a coolant temperature control routine shown in FIG. 6 instead of the coolant temperature control routine shown in FIG. 3. Further, a fuel consumption reduction mode dial switch is provided in the dashboard of the vehicle, instead of the cruise control switch. The fuel consumption reduction mode dial switch is used to turn the fuel consumption reduction mode on and off. When the fuel consumption reduction mode is on, the level of the fuel consumption reduction mode is set to three levels. When the internal combustion engine 2 is placed in the high-load state due to, for example, the driver's operation for sharply accelerating the internal combustion engine 2, the fuel consumption reduction mode is stopped. The other portions of the configuration in the fourth embodiment are the same as those of the configuration in the first embodiment (refer to FIGS. 1 and 2).

The coolant temperature control routine (FIG. 6) is repeatedly executed at constant time intervals. When the routine is started, first, it is determined whether the fuel consumption reduction mode is on, based on the state of the fuel consumption reduction mode dial switch (S200). When the fuel consumption reduction mode dial switch is off (NO in step S200), the coolant temperature is adjusted according to the operating state of the internal combustion engine 2 (S202). This process is the same as the process in step S104 in FIG. 3. The coolant temperature is adjusted based on the map in FIG. 2.

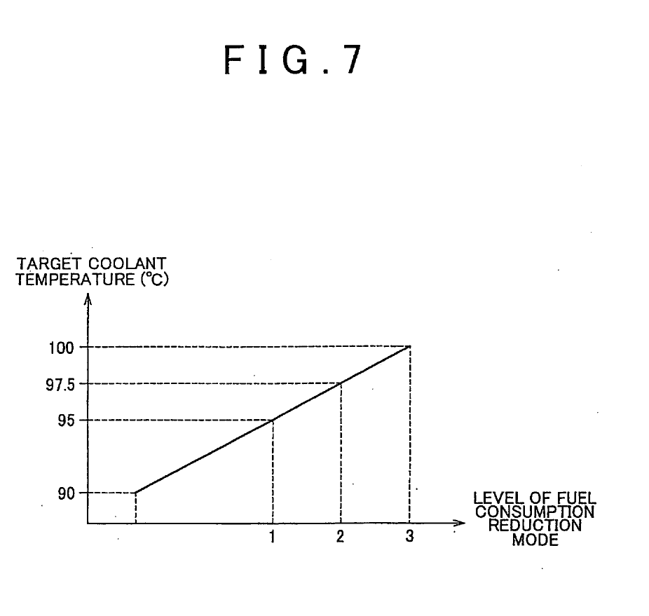

When the fuel consumption reduction mode dial switch is on (YES in step S200), next, the level of the fuel consumption reduction mode is determined (S204). As shown in FIG. 7, when the level of the fuel consumption reduction mode is level 1, the target coolant temperature THWt is set to 95° C. (S206). When the level of the fuel consumption reduction mode is level 2, the target coolant temperature THWt is set to 97.5° C. (S208). When the level of the fuel consumption reduction mode is level 3, the target coolant temperature THWt is set to 100° C. (S210).

Accordingly, when the level of the fuel consumption reduction mode is set to level 1, the coolant temperature THW is adjusted to the coolant temperature (95° C.) that is equal to the upper limit when the coolant temperature THW is adjusted according to the operating state of the internal combustion engine 2 as shown in FIG. 2.

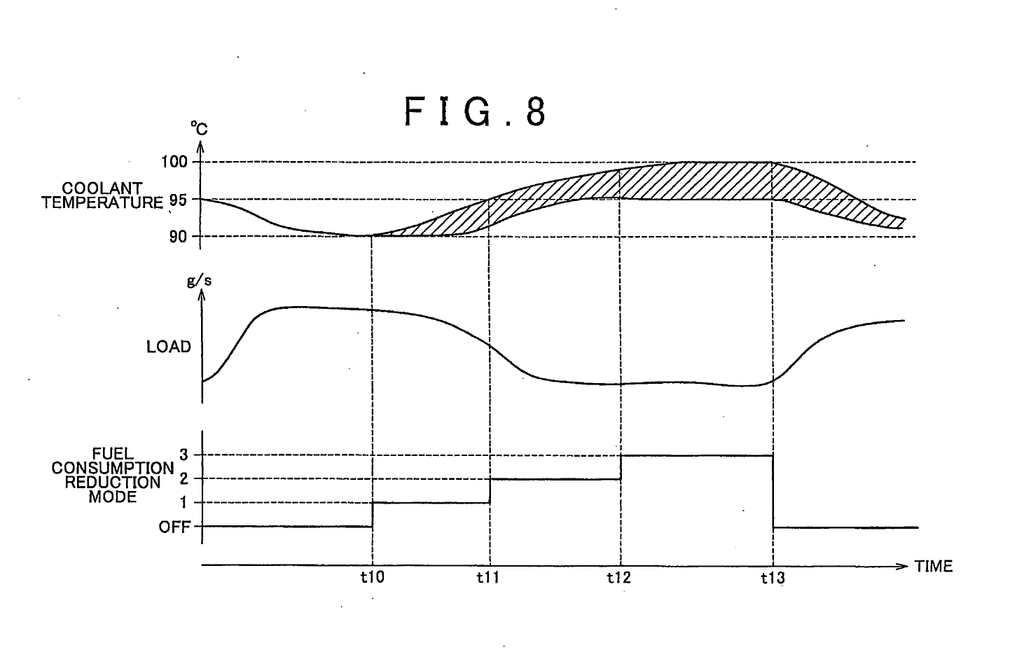

Further, when the level of the fuel consumption reduction mode is set to level 2, the target coolant temperature THWt is set to 97.5° C. that is higher than the upper limit in FIG. 2. When the level of the fuel consumption reduction mode is set to level 3, the target coolant temperature THWt is set to 100° C. that is even higher than the target coolant temperature THWt when the level of the fuel consumption reduction mode is set to level 2. FIG. 8 is a timing chart showing an example of the control according to the fourth embodiment. Because the fuel consumption reduction mode is off before time point t10 (NO in step S200), the coolant temperature is adjusted according to the operating state of the internal combustion engine 2 (S202). When the driver operates the fuel consumption reduction mode dial switch to set the level of the fuel consumption reduction mode to level I at time point t10 (YES in step S200), the target coolant temperature THWt is set to 95° C. (S206). Further, when the driver sets the level of the fuel consumption reduction mode to level 2 at time point t11, the target coolant temperature THWt is set to 97.5° C. (S208). Further, when the driver sets the level of the fuel consumption reduction mode to level 3 at time point t12, the target coolant temperature THWt is set to 100° C. (S210). Thus, the coolant temperature THW is adjusted to a value that is higher than normal by an amount shown by the hatched area in FIG. 8.

When the driver performs, for example, the operation for sharply accelerating the internal combustion engine 2 at time point t13 during the period in which the level of the fuel consumption reduction mode is set to level 3, the fuel consumption reduction mode is automatically off (NO in step S200), and the coolant temperature adjustment is returned to the coolant temperature adjustment according to the operating state of the internal combustion engine 2 as shown in FIG. 2 (S202). However, immediately after the driver performs the acceleration operation, the internal combustion engine 2 is temporarily placed in the high-temperature high-load state. Therefore, the ignition timing is retarded by the anti-knocking control. As a result, the internal combustion engine 2 is slowly accelerated due to the decrease in the power performance of the internal combustion engine 2. However, because the driver recognizes that the driver performs the acceleration operation during the fuel consumption reduction mode, the driver does not feel discomfort.

In the above-described configuration, the fuel consumption reduction dial switch may be regarded as the fuel consumption reduction selection device. The ECU may be regarded as the coolant temperature increase device and the load-based coolant temperature adjustment device. Among the processes executed by the ECU, the processes in step S200, and S204 to S210 may be regarded as the process executed by the coolant temperature increase device. The process, in which the coolant temperature is adjusted according to the operating state of the internal combustion engine 2 (S202), may be regarded as the process executed by the load-based coolant temperature adjustment device.

In the fourth embodiment thus described, the following advantageous effects are obtained. (i) Thus, in the fuel consumption reduction mode that is executed in response to the instruction provided by the driver by operating the fuel consumption reduction dial switch, the coolant temperature THW is increased (S206 to S210). Thus, the coolant temperature is increased in the situation where the driver recognizes that the fuel consumption reduction control is executed. In the situation where the coolant temperature is increased, when the driver performs the acceleration operation, the coolant temperature is high during the high-load operation. As a result, the frequency of occurrence of knocking is increased, and thus, the ignition timing retard control is executed to prevent knocking.

Because the power performance is decreased by the ignition timing retard control, the internal combustion engine 2 is slowly accelerated temporarily. However, at this time, the driver recognizes that the fuel consumption reduction mode is executed in response to the driver's operation of the fuel consumption reduction mode dial switch. Because the driver considers that the internal combustion engine 2 is slowly accelerated due to the influence of the fuel consumption reduction mode, the driver does not feel discomfort.

In this manner, the coolant temperature is increased as compared to the conventional case, without making the driver feel discomfort This further improves fuel efficiency. (ii) It is possible to obtain the same advantageous effect as that described in the section (ii) in the first embodiment.

### Other Embodiments

(a) In each of the above-described embodiments, when the cruise control or the fuel consumption reduction mode is not executed, the coolant temperature is adjusted according to the operated state of the internal combustion engine 2, as shown in FIG. 2. However, this adjustment of the coolant temperature, which is performed at ordinary times, may not be performed. In an internal combustion engine where the adjustment of the coolant temperature shown in FIG. 2 is not executed, when the cruise control or the fuel consumption reduction mode is executed, the coolant temperature THW may be increased. Alternatively, the process, in which the coolant temperature THW is increased, may be executed in the fuel consumption reduction mode. In this case, it is possible to obtain the same advantageous effect as that described in the section (i) in each of the above-described embodiments.

(b) In each of the above-described embodiments, when the cruise control or the fuel consumption reduction mode is executed, the target coolant temperature THWt is fixed to a specific high temperature. Alternatively, when the cruise control or the fuel consumption reduction mode is executed, the target coolant temperature THWt calculated based on FIG. 2 may be corrected to be increased.

For example, in each of the first to third embodiments, the target coolant temperature THWt determined based on the operating state of the internal combustion engine 2 may be uniformly corrected to be increased by 5° C. or by 5%.

In the fourth embodiment, when the level of the fuel consumption reduction mode is set to level 1, the target coolant temperature THWt may be corrected to be increased by 2° C. or by 2%. When the level of the fuel consumption reduction mode is set to level 2, the target coolant temperature THWt may be corrected to be increased by 4° C. or by 4%. When the level of the fuel consumption reduction mode is set to level 3, the target coolant temperature THWt may be corrected to be increased by 6° C. or by 6%. (c) In the configuration described with reference to FIG. 1, the coolant temperature adjustment mechanism, which adjusts the coolant temperature using the electronic thermostat, is employed. However, the ratio between the flow amount of the coolant that passes through the radiator for heat dissipation, and then flows into the inlet passage, and the flow amount of the coolant that flows in the main bypass passage, and then flows into the inlet passage may be adjusted using an electromagnetic valve instead of the electronic thermostat.

(d) The values of the target coolant temperature THWt shown in the above-described embodiments are example values. The value of the target coolant temperature THWt is appropriately adjusted depending on the type of the internal combustion engine. (e) In the fourth embodiment, when the fuel consumption reduction mode is executed, the target coolant temperature THWt is set to change in a stepwise manner. However, the target coolant temperature THWt may be set to continuously change.

What is claimed is:

1. A control apparatus for an internal combustion engine for a vehicle, comprising:
a coolant temperature increase device that increases a coolant temperature that is a temperature of coolant for the internal combustion engine;
an operation control device that executes an engine control in response to an instruction provided by a driver, wherein power performance provided by the internal combustion engine in response to an operation performed by the driver is lower than power performance that is normally provided in response to the operation performed by the driver during the engine control; and
an ignition timing retard control device that executes an ignition timing retard control to prevent knocking,
wherein when the operation control device executes the engine control, the coolant temperature increase device increases the coolant temperature.

2. The control apparatus according to claim 1, wherein when the coolant temperature is above a predetermined temperature after the engine control is stopped, the ignition timing retard control device retards an ignition timing.

3. The control apparatus according to claim 1, wherein the engine control includes a fuel consumption reduction mode.

4. The control apparatus according to claim 3, wherein in the fuel consumption reduction mode, the operation control device executes at least one of a control that limits a combustion to a lean combustion or a stratified combustion, a control that limits an increase amount, by which a throttle valve opening degree is increased, to a smaller amount than normal, and a control that sets an upper limit of a rotational speed of the internal combustion engine, to a lower value than normal.

5. The control apparatus according to claim 1, further comprising
a load-based coolant temperature adjustment device that increases the coolant temperature as a load of the internal combustion engine decreases when the operation control device does not execute the engine control, wherein the coolant temperature increase device adjusts the coolant temperature to a higher value than a value to which the coolant temperature is adjusted by the load-based coolant temperature adjustment device.

6. A control apparatus for an internal combustion engine for a vehicle, comprising:
a coolant temperature increase device that increases a coolant temperature that is a temperature of coolant for the internal combustion engine;
an operation control device that executes an engine control in response to an instruction provided by a driver, wherein the internal combustion engine is accelerated more slowly than normal during the engine control; and
an ignition timing retard control device that executes an ignition timing retard control to prevent knocking,
wherein when the operation control device executes the engine control,.the coolant temperature increase device increases the coolant temperature.

7. The control apparatus according to claim 6, wherein when the coolant temperature is above a predetermined temperature after the engine control is stopped, the ignition timing retard control device executes the ignition timing retard control.

8. The control apparatus according to claim 6, wherein the engine control includes a cruise control.

9. The control apparatus according to claim 6, further comprising
a load-based coolant temperature adjustment device that increases the coolant temperature as a load of the internal combustion engine decreases when the operation control device does not execute the engine control wherein the coolant temperature increase device adjusts the coolant temperature to a higher value than a value to which the coolant temperature is adjusted by the load-based coolant temperature adjustment device.

10. A control apparatus for an internal combustion engine for a vehicle, comprising:
a coolant temperature increase device that increases a coolant temperature that is a temperature of coolant for the internal combustion engine;
a fuel consumption reduction mode selection device that selects a fuel consumption reduction mode in response to an instruction provided by a driver; and
an ignition timing retard control device that executes an ignition timing retard control to prevent knocking,
wherein when the fuel consumption reduction mode is selected, the coolant temperature increase device increases the coolant temperature.

11. The control apparatus according to claim 10, further comprising
a load-based coolant temperature adjustment device that increases the coolant temperature as a load of the internal combustion engine decreases when the fuel consumption reduction mode is not selected, wherein the coolant temperature increase device adjusts the coolant temperature to a higher value than a value to which the coolant temperature is adjusted by the load-based coolant temperature adjustment device.

12. The control apparatus according to claim 10, wherein the coolant temperature increase device adjusts the coolant temperature according to a load of the internal combustion engine during the engine control.

13. A control method for an internal combustion engine for a vehicle, comprising
increasing a temperature of coolant for the internal combustion engine, in a situation where an ignition timing retard control device is provided to execute an ignition timing retard control to prevent knocking, and a driver recognizes that an engine control is executed, wherein power performance provided by the internal combustion engine in response to an operation performed by a driver is lower than power performance that is normally provided in response to the operation performed by the driver during the engine control.

14. A control method for an internal combustion engine for a vehicle, comprising
increasing a temperature of coolant for the internal combustion engine, in a situation where an ignition timing retard control device is provided to execute an ignition timing retard control to prevent knocking, and a driver recognizes that an engine control is executed, wherein the internal combustion engine is accelerated more slowly than normal during the engine control.

15. A control method for an internal combustion engine for a vehicle, comprising
increasing a temperature of coolant for the internal combustion engine, in a situation where an ignition timing retard control device is provided to execute an ignition timing retard control to prevent knocking, and a fuel consumption reduction mode is selected in response to an instruction provided by a driver.
